(19) United States
(12) Patent Application Publication
(10) Pub. No.: US 2024/0168713 A1
(43) Pub. Date: May 23, 2024

(54) PROCESSING CIRCUIT

(71) Applicant: Infineon Technologies AG, Neubiberg (DE)

(72) Inventor: Erich Wenger, Muenchen (DE)

(21) Appl. No.: 18/485,550

(22) Filed: Oct. 12, 2023

(30) Foreign Application Priority Data
Nov. 17, 2022 (DE) 102022130488.4

(51) Int. Cl. G06F 7/523; G06F 7/50; G06F 7/544

(52) U.S. Cl. CPC G06F 7/523; G06F 7/50; G06F 7/5443

(57) ABSTRACT

A processing circuit including a first multiplier to multiply least significant portions of a first and a second operand, a second multiplier to multiply a sum of a most and the least significant portion of the first operand with the sum of a most and the least significant portion of the second operand and the least significant portion of the second operand, a third multiplier to multiply the most significant portions of the first and the second operand and an output circuit to determine an output sum including the result of the first multiplier, the result of the third multiplier times two to the power of two times the bit number of the least significant portions, and, if enabled, the result of the second multiplier minus the results of the first and the third multiplier, times two to the power of the bit number of the least significant portions.

### TECHNICAL FIELD

The present disclosure relates to processing circuits.

### BACKGROUND

In cryptographic processing of data, such as calculation of a signature, encryption or decryption of data, the multiplication of integers are typical operations which are to be carried out a high number of times. This is in particular the case in asymmetric cryptography based on ECC (elliptic curve cryptography) or RSA (Rivest, Shamir, Adleman) but also PQC (post-quantum cryptography). To achieve a high processing speed, a hardware processing circuit is desirable which is optimized with respect to area and power consumption for efficiently carrying out multiplications, in particular in context of cryptography.

### SUMMARY

According to various aspects, a processing circuit is provided comprising
a first input configured to receive a first operand consisting of a most significant bit portion holding the most significant bits of the first operand and a least significant bit portion holding the least significant bits of the first operand;
a second input configured to receive a second operand consisting of a most significant bit portion holding the most significant bits of the second operand and a least significant bit portion holding the least significant bits of the second operand;
a control input configured to receive a full operand enable signal;
a first multiplier configured to multiply the least significant bit portion of the first operand with the least signification bit portion of the second operand;
a second multiplier configured to multiply the sum of the most significant bit portion of the first operand and the least significant bit portion of the first operand with the sum of the most significant bit portion of the second operand and the least significant bit portion of the second operand;
a third multiplier configured to multiply the most significant bit portion of the first operand with the most signification bit portion of the second operand and
an output circuit configured to
   determine an output sum including
      the result of the multiplication by the first multiplier,
      the result of the multiplication by the third multiplier times two to the power of two times the number of bits which the least significant bit portions of the operands each hold, and
      depending on whether or not the full operand enable signal is set, the result of the multiplication by the second multiplier minus the result of the multiplication by the first multiplier and minus the result of the multiplication by the third multiplier, times two to the power of the number of bits which the least significant bit portions of the operands each hold and
   output the output sum as result.

### BRIEF DESCRIPTION OF THE DRAWINGS

In the drawings, similar reference characters generally refer to the same parts throughout the different views. The drawings are not necessarily to scale, emphasis instead generally being placed upon illustrating the principles of the disclosed aspects. In the following description, various aspects are described with reference to the following drawings, in which:

FIG. 1 shows an example of a data processing device.

FIG. 2 shows a processing circuit for multiplying two 64-bit operands having a full operand mode and a SIMD (single instruction multiple data) mode according to an aspect.

FIG. 3 shows a processing circuit configured to consider an additive input operand according to an aspect.

FIG. 4 shows a processing circuit configured to consider an additive input operand according to another aspect.

FIG. 5 shows a processing circuit for two 64-bit operands having a full multiplication mode and a SIMD mode for four parallel 16*16 bit multiplications according to an aspect.

FIG. 6 shows a processing circuit according to an aspect.

### DETAILED DESCRIPTION

The following detailed description refers to the accompanying drawings that show, by way of illustration, specific details and aspects of this disclosure in which the disclosed aspects may be practiced. Other aspects may be utilized and structural, logical, and electrical changes may be made without departing from the scope of the disclosed aspects. The various aspects of this disclosure are not necessarily mutually exclusive, as some aspects of this disclosure can be combined with one or more other aspects of this disclosure to form new aspects.

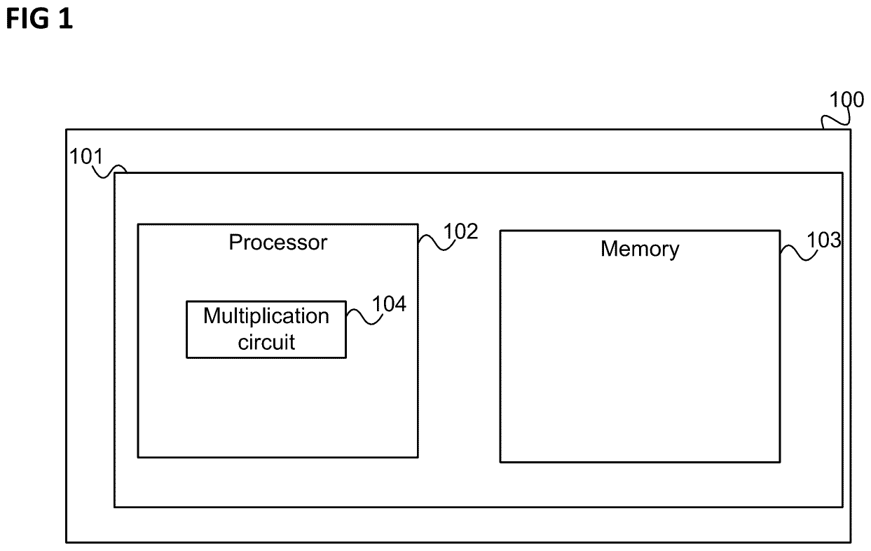

FIG. 1 shows an example of a data processing device 100.

The data processing device 100 may be a computer, or a controller or a microcontroller, e.g. in a vehicle, e.g. an ECU (Electronic Control Unit) in a car. It may also be a chip card integrated circuit (IC) of a smart card such as a smart card of any form factor, e.g. for a passport or for a SIM (Subscriber Identity Module).

The data processing device 100 has an integrated circuit in the form of a chip 101. The chip 101 may be a control chip and implement a processor 102 and a memory 103, e.g. a RAM (Random Access Memory). It should be noted that the processor 102 and the memory 103 may also be implemented on separate chips. The chip 101 may also be, for example, an RFID (Radio Frequency Identification) chip or implement a SIM (Subscriber Identity Module) for a mobile phone. The chip 101 may be provided for a security application, i.e. may be a security chip. For example, the memory 103 stores secret data used for a cryptographic operation, e.g. to authenticate a user or to encrypt/decrypt or to sign data, for example according to an asymmetric cryptography scheme. Accordingly, the data processing device may be a cryptographic processing device, i.e. a device that performs cryptographic processing of data.

Asymmetric cryptography based on ECC (elliptic curve cryptography) or RSA (Rivest, Shamir, Adleman) require, for next generation cryptography, multiplications of a certain bit length (like 64 bit) while lattice-based PQC (post quantum cryptography) can in contrast be expected to require bit multiplications of smaller length, as many of the lattice-based PQC parameter sets use moduli of less than 32 bits.

In order to take advantage of a 64-bit datapath, the PQC operands may be arranged in a SIMD (single instruction multiple data) fashion, where two 32-bit values are processed simultaneously with a 64-bit datapath.

In this context, a 64×64 bit multiplication can be seen as a full multiplication (i.e. full operand processing) where a first value, represented by 64 bits, is multiplied with a second value, also represented by 64 bits, to generate a 128-bit product. Two 32×32 bit multiplications may instead by seen as a SIMD (single instruction multiple data) operation to generate two 64-bit products: of a first 64-bit operand, the higher 32 bits (i.e. the most significant 32 bits) are taken as a first value and multiplied with the higher 32 bits of a second 64-bit operand (taken as a second value) and, in parallel, the lower 32 bits (i.e. the least significant 32 bits) of the first are taken as a third value and multiplied with the lower 32 bits of the second 64-bit operand (taken as a fourth value).

According to various aspects, a hardware processing circuit 104 is provided in the data processing device (here as part of the processor 102) which supports a full operand mode (e.g. multiplication of two 64 bit values) and a SIMD mode (e.g. two multiplications of two 32 bit values each).

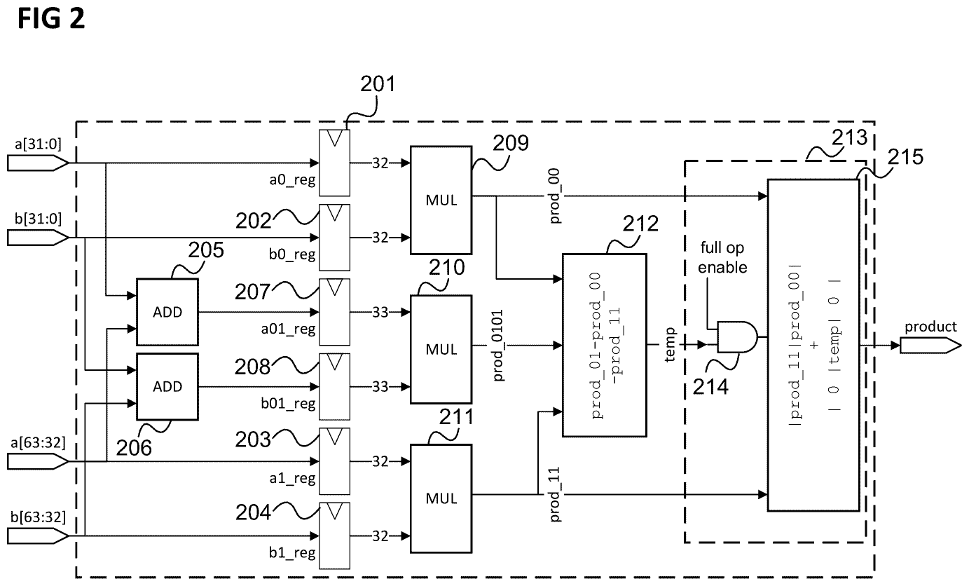

FIG. 2 shows a processing circuit 200 for multiplying two 64-bit operands having a full operand mode and a SIMD mode according to an aspect.

The processing circuit 200 receives two 64-bit operands which are denoted as a[63:0] and b[63:0]. The least significant bit half of the first operand a0:=a[31:0] is stored by a first register 201. The least significant bit half of the second operand b0:=b[31:0] is stored by a second register 202. The most significant bit half of the first operand a1:=a[63:32] is stored by a third register 203. The most significant bit half of the second operand b1:=b[63:32] is stored by a fourth register 204. It should be noted that a register is understood as a set of single-bit storage elements (usually flip-flops) to store multiple bits.

Further, a first adder 205 receives the least significant bit half of the first operand a0 and the most significant bit half of the first operand a1, adds them and stores the result in a fifth register 207.

Similarly, a second adder 206 receives the least significant bit half of the second operand b0 and the most significant bit half of the second operand b1, adds them and stores the result in a sixth register 208.

It should be noted that every bit half (or, in general, “bit portion” in case that the operands are not divided in a 50-50 manner) is interpreted as the binary value that the bits it contains represent if processed by, for example, an adder or multiplier.

A first multiplier 209 then receives a0 and b0 from the first register 201 and the second register 201 and calculates a0*b0 (referred to as prod_00).

A second multiplier 210 receives a0+a1 and b0+b1 from the fifth register 207 and the sixth register 208 and calculates (a0+a1)*(b0+b1) (referred to as prod_0101.

A third multiplier 211 then receives a1 and b1 from the third register 203 and the fourth register 204 and calculates a1*b1 (referred to as prod_11).

A third adder 212 then calculates temp:=prod_0101-prod_00-prod_11. This may be seen as a correction term for a full operand multiplication.

The processing circuit 200 further comprises an output circuit 213 which comprises an AND gate 214 which receives temp and a full operand enable signal and a fourth adder 215 which receives the output of the AND gate 214 as well as prod_00 and prod_11 and generates the processing circuit's output “product”.

If the full operand enable signal is set, the fourth adder 215 receives prod_00, prod_11 and temp. It then calculates the output as

product=prod_11*W²+temp*W+prod_00
where W=2³²
such that
product=a1b1*W²+(a0b1+a1b0)*W+a0b0=(a1*W+a0)*(b1*W+b0)
which is the correct result for the full multiplication. To see that this is true, note that temp=prod_0101-prod_00-prod_11=(a0+a1)*(b0+b1)−a0b0−a1b1=a0b1+a1b0.

If the full operand enable signal is not set, the fourth adder 215 receives prod_00 and prod_11 and 0 instead of temp (or, in other words, temp is set to 0). It thus calculates the output as

product=prod_11*W²+prod_00
which is the correct result for the SIMD multiplication, namely the value pair (prod_11, prod_00)=(a1b1, a0b0), each represented by 64 bit since the result of each 32*32 bit multiplication may have 64 bit.

It should be noted that if the full operand enable signal is not set, this enables SIMD mode. So, having the full operand enable signal to a level such that full multiplication is disabled is equivalent to enabling SIMD mode, i.e. setting a SIMD enable signal (which is inverse to the full operand enable signal in a logical sense i.e. it is set if the other is not set and vice versa).

Thus, by enabling SIMD mode, the hardware multiplier 200 can be directly used to compute the single-instruction-multiple-data (SIMD) result: a0b0, a1b1. With the AND-gate 214, the “temp” term (i.e. full operand correction term) is gated and the two products can be directly read on the output of the hardware multiplier 200. It should be noted that during SIMD operation (i.e. a sequence of SIMD multiplications), the update of the fifth register 207 and the sixth register 208 may be switched off and the second adder 210 is idle such that power consumption is reduced with respect to full multiplication mode.

In full multiplication mode, i.e. when SIMD mode is not enabled, the calculation of product as

product=a1b1*W²+(a0b1+a1b0)*W+a0b0=(a1*W+a0)*(b1*W+b0)
is achieved with only three multiplications (the multiplications with W and W² can be implemented with shifters) rather than the four multiplications when using the straightforward calculation

product=(a1*W+a0)*(b1*W+b0)=a1b1*W²+a1b0*W+a0b1*W+a0b0.

This saves approximately 20% chip area.

Moreover, according to one aspect, as illustrated in FIG. 2, the first adder 205 and the second adder 206 are arranged in front of the fifth register 207 and the sixth register 208 (which are for example implemented as rising-edge flip-flops), respectively, such that the critical path (e.g. between the fifth register 207 and the sixth register 208 and a register in which the output “product” is stored) is to a multiplier which uses the straightforward calculation approach. By having the first adder 205 and the second adder 206 before the fifth register 207 and the sixth register 208, combined with the multiplication approach using only three multipliers 209, 210, 211, approximately 30% power can be saved in comparison to the straightforward calculation approach.

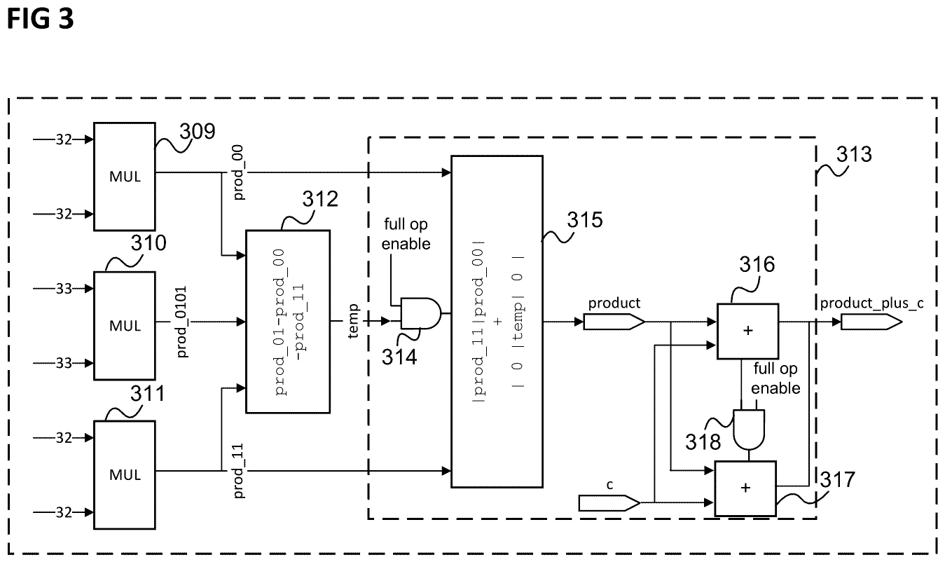

According to various aspects, the hardware multiplier may further allow taking into account an additive input operand c (which for example also has 128 bit) such that it calculates a*b+c (i.e. performs an affine operation rather than a multiplication). This is illustrated in FIG. 3.

FIG. 3 shows a processing circuit 300 configured to consider an additive input operand according to an aspect.

Similar to the processing circuit 200 of FIG. 2, the processing circuit 300 comprises a first multiplier 309, a second multiplier 310, a third multiplier 311, a third adder 312, an AND gate 314 and a fourth adder 315. For simplicity, the part in front of the multipliers 309, 310, 311 is left out in FIG. 3. It is similar to FIG. 2 (i.e. comprising the adders 205, 206 and the registers 201, 202, 203, 204, 207, 208).

At the output of the fourth adder 314, the least significant bit half of the result “product” is fed to a fifth adder 316 and the most significant bit half of the result “product” is fed to a sixth adder 317. The fifth adder 316 further is supplied with the least significant bit half (c0) of the additive input operand c and the sixth adder 317 is further supplied with the most significant bit half (c1) of the additive input operand c. The carry output of the fifth adder 316 is input to a second AND gate 318 which receives as second input the full operand enable signal. The output of the second AND gate 318 is fed to the carry input of the sixth adder 317. This allows calculating a*b+c in full multiplication mode and a1*b1+c1 and a0*b0+c0 in SIMD mode.

The pair of output values of the fifth adder 318 and the sixth adder 317 forms the affine operation result “product_plus_c”.

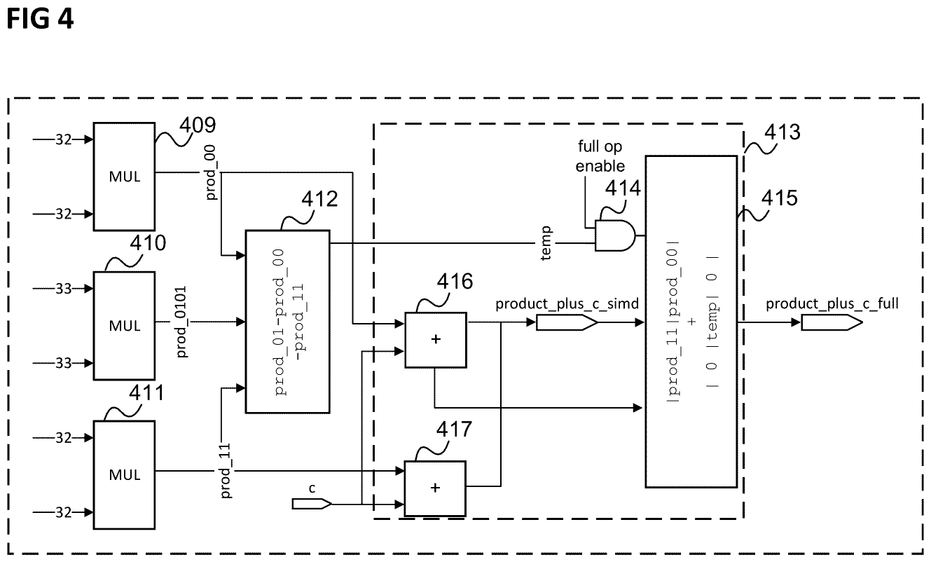

The fifth adder 316, the sixth adder 317 and the second AND gate 318 may also be moved in front of the fourth adder 315 as it is illustrated in FIG. 4.

FIG. 4 shows a processing circuit 400 configured to consider an additive input operand according to another aspect.

Similarly to the processing circuit 300, the processing circuit 400 comprises a first multiplier 409, a second multiplier 410, a third multiplier 411, a third adder 412, an AND gate 414, a fourth adder 415, a fifth adder 416, a sixth adder 417. Again, for simplicity, the part in front of the multipliers 409, 410, 411 is left out in FIG. 4.

The fifth adder 416 receives prod_00 and the least significant bit half (c0) of the additive input operand c and the sixth adder 417 receives prod_11 and the most significant bit half (c0) of the additive input operand c.

In the aspect of FIG. 4, the carry propagation from the fifth adder 416 to the sixth adder 417 is shifted to the fourth adder 416 (it may be shifted to a subsequent clock cycle by storing it in a register and propagate it from there). This means that the second AND gate 418 is omitted and the carry output of the fifth adder 416 goes into the fourth adder 416. The SIMD output product_plus_c_simd=(a1*b1+c1, a0*b0+c0) can then be directly taken in front of the fourth adder 416 (without having the operation of the fourth adder 415 in the critical path). The fourth adder 416 propagates the carry and calculates the full multiplication output product_plus_c_integer=a*b+c.

The fifth adder 416 and the sixth adder 417 may be considered as part of the output circuit 413. Similarly, the fifth adder 316 and the sixth adder 317 of FIG. 3 may be considered as part of the output circuit 313.

It should be noted that while in the above examples, the two input operands have a bit length of 64, also other bit lengths of the operands and values are possible (e.g. both a and b may have 128 bits and each be separated in two 64 bit halves etc.)

Moreover, an architecture may also be used which divides each operand in more than two portions (or sub-words). As an example, in the following, a circuit is described in which two 64-bit operands are each divided into four 16-bit portions (rather than two 32-bit portions as in the examples of FIGS. 2 to 4).

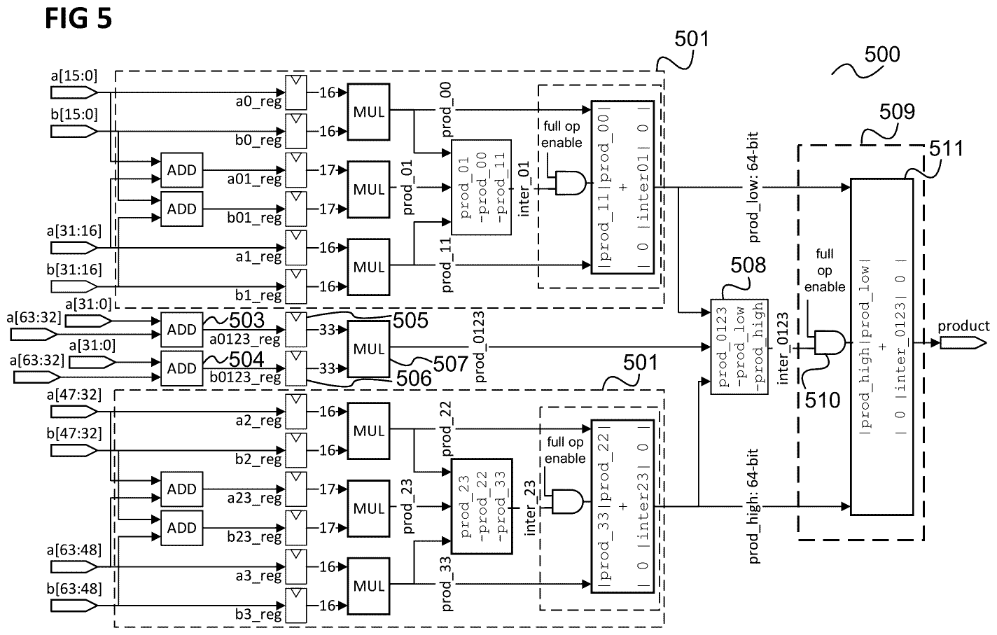

FIG. 5 shows a processing circuit 500 for two 64-bit operands having a full multiplication mode and a SIMD mode for two parallel 32*32 bit multiplications or for four parallel 16*16 multiplications according to an aspect.

The processing circuit 500 comprises a first sub-circuit 501 and a second sub-circuit 502 which each correspond to the processing circuit 200 of FIG. 2 with the difference that the inputs to the multipliers have a bit width of 16 and 17 bit, respectively, instead of 32 and 33 bit, respectively, since the 64 bit operands a[63:0] and b[63:0] are divided into 16 bit portions a3:=a[63:48], a2:=a[47:32], a1:=a[31:16], a0:=a[15:0] and b3:=b[63:48], b2:=b[47:32], b1:=b[31:16], b0:=b[15:0] which are processed by the sub-circuits 501, 502 instead of the 32 bit portions as in the examples of FIGS. 2 to 4.

Further, a first adder 503 receives the least significant bit half of the first operand (a0, a1) and the most significant bit half of the first operand (a2, a3), adds them and stores the result in a first register 505. Similarly, a second adder 504 receives the least significant bit half of the second operand (b0, b1) and the most significant bit half of the second operand (b2, b3), adds them and stores the result in a second register 506. These two values are multiplied by a multiplier 507.

The result of the first sub-circuit 501 (denoted as “prod_low”), the result of the second sub-circuit 502 (denoted as “prod_high”) and the result of the multiplier 503 (denoted as “prod_0123”) are fed to a third adder 508 which calculates prod_0123-prod_low-prod_high. The result is denoted as inter_0123.

The processing circuit 500 further comprises an output circuit 509 which comprises an AND gate 510 which receives inter_0123 and the full operand enable signal and a fourth adder 511 which receives the output of the AND gate 510 as well as prod_low and prod_high and generates the processing circuit's result “product”.

In full multiplication mode, “product” should be equal to

(a3*W³+a2*W²+a1*W+a0)*(b3*W³+b2*W²+b1*W+b0)

Analogously to the case of dividing each operand into two portions of FIG. 2, the processing circuit 500 achieves this as follows.

In the first sub-circuit 501 the following products are calculated (wherein the additions may again be performed before the registers to reduce critical path length):

prod_00=a0b0

prod_01=(a0+a1)*(b0+b1)

prod_11=a1b1

In the second sub-circuit 501 the following products are calculated (wherein the additions may again be performed before the registers to reduce critical path length):

prod_22=a2b2

prod_23=(a2+a3)*(b2+b3)

prod_33=a3b3

Further, the first sub-circuit 501 and the second sub-circuit 502 calculate, similar to the calculation of temp in the processing circuit 200 of FIG. 2

inter_01=(prod_01−a1b1−a0b0)

and

inter_23=(prod_23−a3b3−a2b2)

respectively
and calculate, as output (when full multiplication enable is set),

prod_low=a1b1*W²+inter_01*W+a0b0

and

prod_high=a3b3*W²+inter_02*W+a2b2

The “middle” multiplier 507 calculates

prod_0123=(a1*W+a0+b1*W+b0)*(a3*W+a2+b3*W+b2)

The adder 508 calculates

inter_0123=prod_0123−prod_low−prod_high

The output circuit 509 then calculates (if full multiplication is enabled

product=prod_high*W⁴+inter_0123*W²+prod_low

which is the correct result for the multiplication of a and b.

The products a0b0, a1b1, a2b2, a3b3 are output as SIMD result (when full multiplication enable is not set) since inter_01, inter_23 and inter_0123 are gated.

For full multiplication of two 64-bit words, four 16-bit, two 17-bit and one 33-bit multiplication are thus required. The processing circuit 500 is about 10% larger than the two word portion design of FIG. 2 and has a similar power profile.

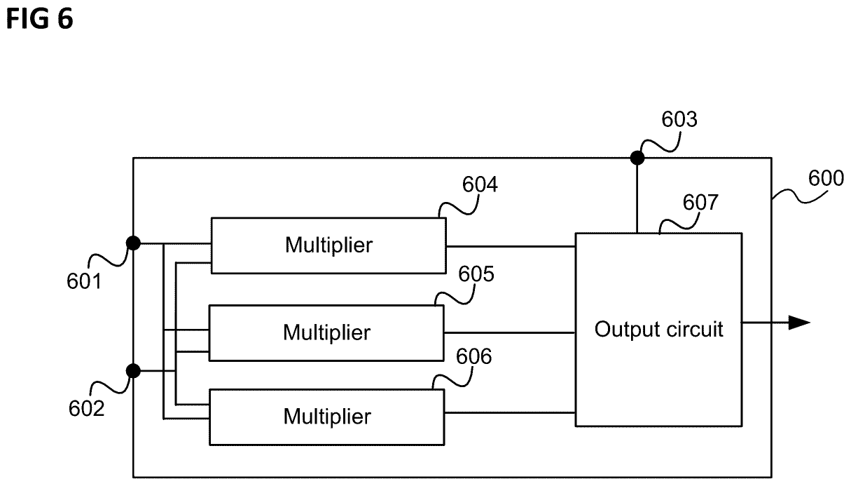

In summary, according to various aspects, a processing circuit is provided as illustrated in FIG. 6.

FIG. 6 shows a processing circuit 600 according to an aspect.

The processing circuit 600 comprises a first input 601 configured to receive a first operand consisting of a most significant bit portion holding the most significant bits of the first operand and a least significant bit portion holding the least significant bits of the first operand and a second input 602 configured to receive a second operand consisting of a most significant bit portion holding the most significant bits of the second operand and a least significant bit portion holding the least significant bits of the second operand.

The processing circuit 600 further comprises a control input 603 configured to receive a full operand enable signal, a first multiplier 604 configured to multiply the least significant bit portion of the first operand with the least signification bit portion of the second operand, a second multiplier 605 configured to multiply the sum of the most significant bit portion of the first operand and the least significant bit portion of the first operand with the sum of the most significant bit portion of the second operand and the least significant bit portion of the second operand and a third multiplier 606 configured to multiply the most significant bit portion of the first operand with the most signification bit portion of the second operand.

The processing circuit 600 further comprises an output circuit 607 configured to
determine an output sum including (i.e. a sum of or a sum of at least)
   the result of the multiplication by the first multiplier,
   the result of the multiplication by the third multiplier times two to the power of two times the number of bits which the least significant bit portions of the operands each hold, and
   depending on whether or not the full operand enable signal is set, the result of the multiplication by the second multiplier minus the result of the multiplication by the first multiplier and minus the result of the multiplication by the third multiplier, times two to the power of the number of bits which the least significant bit portions of the operands each hold and
output the output sum as result.

According to various aspects, an processing circuit has an architecture to perform an operation which includes a multiplication wherein the multiplication is separated in three sub-multiplications wherein two produce the SIMD results and one produces the correction term for a full operation. The correction term for the full operation may be gated such that the circuit may be switched between a SIMD mode and a full operand mode.

In the above and in the following examples and aspects, “sum” refers to the arithmetic sum. Moreover, an “adder” may mean an “adding circuit”. Nevertheless, “adder” and “adding circuit” may be used to distinguish two components (which both have the function of an adder).

Various Examples are described in the following.

Example 1 is a processing circuit as described above with reference to FIG. 6.

Example 2 is the processing circuit of example 1, comprising a first adder configured to calculate the sum of the most significant bit portion of the first operand and the least significant bit portion of the first operand and to store the sum of the most significant bit portion of the first operand and the least significant bit portion of the first operand in a first register and comprising a second adder configured to calculate the sum of the most significant bit portion of the second operand and the least significant bit portion of the second operand and to store the sum of the most significant bit portion of the second operand and the least significant bit portion of the second operand in a second register, wherein the second multiplier is configured to receive the sum of the most significant bit portion of the first operand and the least significant bit portion of the first operand from the first register and to receive the sum of the most significant bit portion of the second operand and the least significant bit portion of the second operand from the second register.

Example 3 is the processing circuit of example 2, comprising further registers configured to store the most significant bit portion of the first operand, the least significant bit portion of the first operand, the most significant bit portion of the second operand and the least significant bit portion of the second operand, wherein the first multiplier is configured receive the least significant bit portion of the first operand and the least signification bit portion of the second operand from the further registers and the third multiplier is configured receive the most significant bit portion of the first operand and the most signification bit portion of the first operand from the further registers.

Example 4 is the processing circuit of any one of examples 1 to 3, further comprising a third input configured to receive a third operand, wherein the output sum further includes the third operand and wherein the output circuit is configured to propagate a carry from a low significant bit portion of the output sum to a most significant bit portion of the output sum if the full operand enable signal is set.

Example 5 is the processing circuit of example 4, wherein the output circuit comprises a first adding circuit configured determine the sum of the result of the multiplication by the first multiplier and the third operand, a second adding circuit configured to determine the sum of the result of the multiplication by the second multiplier and the third operand and a third adding circuit configured to add
the sum determined by the first adding circuit,
the sum determined by the second adding circuit,
if the full operand enable signal is set, the result of the multiplication by the second multiplier minus the result of the multiplication by the first multiplier and minus the result of the multiplication by the third multiplier, times two to the power of the number of bits which the least significant bit portions of the operands each hold and
if the full operand enable signal is set, the carry from the sum determined by the first adding circuit.

Example 6 is the processing circuit of example 5, wherein the output circuit is configured to disable propagation of the carry from the low significant bit portion of the output sum to the most significant bit portion of the output sum if the full operand enable signal is not set.

Example 7 is the processing circuit of example 5 or 6, wherein the low significant portion of the output sum comprises two times the number of bits which the least significant bit portions of the operands each hold.

Example 8 is the processing circuit of any one of examples 1 to 7, wherein the output circuit is configured to omit the result of the multiplication by the second multiplier minus the result of the multiplication by the first multiplier and minus the result of the multiplication by the third multiplier, times two to the power of the number of bits which the least significant bit portions of the operands each hold from the output sum if the full operand enable signal is not set.

Example 9 is the processing circuit of any one of examples 1 to 8, wherein the output circuit comprises a summing circuit configured to calculate the output sum and comprising a gating circuit configured to supply the result of the multiplication by the second multiplier minus the result of the multiplication by the first multiplier and minus the result of the multiplication by the third multiplier to the summing circuit if the full operand enable signal is set and to supply a zero to the summing circuit if the full operand enable signal is not set.

Example 10 is a data processing circuit comprising a first sub-circuit and a second sub-circuit each according to the processing circuit of any one of examples 1 to 9, an input circuit configured to supply a least significant bit portion of a first binary value as first operand to the first sub-circuit and a least significant bit portion second binary value as second operand to the first sub-circuit, an additional multiplier configured to multiply the sum of the most significant bit portion of the first binary value and the least significant bit portion of the first binary value with the sum of the most significant bit portion of the second binary value and the least significant bit portion of the second binary value and an additional output circuit configured to determine an output sum including
the result output by the first sub-circuit,
the result output by the second sub-circuit times two to the power of two times the number of bits which the least significant bit portions of the binary values each hold,
and, depending on whether or not the full operand enable signal is set, the result of the multiplication by the additional multiplier minus the result output by the first sub-circuit and minus result output by the second sub-circuit, times two to the power of the number of bits which the least significant bit portions of the binary values each hold and
   to output the output sum as end result.

Although specific aspects have been illustrated and described herein, it will be appreciated by those of ordinary skill in the art that a variety of alternate and/or equivalent implementations may be substituted for the specific aspects shown and described without departing from the scope of the present disclosed aspects. This application is intended to cover any adaptations or variations of the specific aspects discussed herein. Therefore, it is intended that this invention be limited only by the claims and the equivalents thereof.

### REFERENCE SIGNS

100 data processing device
101 chip
102 processor
103 memory
104 hardware processing circuit
200 processing circuit
201-204 registers
205, 206 adders
207, 208 registers
209-211 multipliers
212 adder
213 output circuit
214 AND gate
215 adder
300 processing circuit
309-311 multipliers
312 adder
313 output circuit
314 AND gate
315-317 adders
400 processing circuit
409-411 multipliers
412 adder
413 output circuit
414 AND gate
415-417 adders
500 processing circuit
501, 502 sub-circuits
503, 504 adders
505, 506 registers
507 multiplier
508 adder
509 output circuit
510 AND gate
511 adder
600 processing circuit
601, 602 operand inputs
603 control input
604-606 multipliers
607 output circuit

1. A processing circuit, comprising:
a first input configured to receive a first operand including a most significant bit portion holding the most significant bits of the first operand and a least significant bit portion holding the least significant bits of the first operand;
a second input configured to receive a second operand including a most significant bit portion holding the most significant bits of the second operand and a least significant bit portion holding the least significant bits of the second operand;
a control input configured to receive a full operand enable signal;
a first multiplier configured to multiply the least significant bit portion of the first operand with the least signification bit portion of the second operand;
a second multiplier configured to multiply a sum of the most significant bit portion of the first operand and the least significant bit portion of the first operand with a sum of the most significant bit portion of the second operand and the least significant bit portion of the second operand;
a third multiplier configured to multiply the most significant bit portion of the first operand with the most signification bit portion of the second operand; and
an output circuit configured to:
determine an output sum including:
a result of the multiplication by the first multiplier,
a result of the multiplication by the third multiplier times two to the power of two times a number of bits which the least significant bit portions of the operands each hold, and
depending on whether or not the full operand enable signal is set, the result of the multiplication by the second multiplier minus the result of the multiplication by the first multiplier and minus the result of the multiplication by the third multiplier, times two to the power of the number of bits which the least significant bit portions of the operands each hold; and
to output the output sum as a result.

2. The processing circuit of claim 1, further comprising:
a first adder configured to calculate the sum of the most significant bit portion of the first operand and the least significant bit portion of the first operand, and to store the sum of the most significant bit portion of the first operand and the least significant bit portion of the first operand in a first register; and
a second adder configured to calculate the sum of the most significant bit portion of the second operand and the least significant bit portion of the second operand, and to store the sum of the most significant bit portion of the second operand and the least significant bit portion of the second operand in a second register,
wherein the second multiplier is configured to receive the sum of the most significant bit portion of the first operand and the least significant bit portion of the first operand from the first register and to receive the sum of the most significant bit portion of the second operand and the least significant bit portion of the second operand from the second register.

3. The processing circuit of claim 2, further comprising:
further registers configured to store the most significant bit portion of the first operand, the least significant bit portion of the first operand, the most significant bit portion of the second operand, and the least significant bit portion of the second operand,
wherein the first multiplier is configured to receive the least significant bit portion of the first operand and the least signification bit portion of the second operand from the further registers, and the third multiplier is configured to receive the most significant bit portion of the first operand and the most signification bit portion of the first operand from the further registers.

4. The processing circuit of claim 1, further comprising:
a third input configured to receive a third operand,
wherein the output sum further includes the third operand, and the output circuit is configured to propagate a carry from a low significant bit portion of the output sum to a most significant bit portion of the output sum if the full operand enable signal is set.

5. The processing circuit of claim 4, wherein the output circuit comprises a first adding circuit configured to determine the sum of the result of the multiplication by the first multiplier and the third operand, a second adding circuit configured to determine the sum of the result of the multiplication by the second multiplier and the third operand, and a third adding circuit configured to add:
the sum determined by the first adding circuit,
the sum determined by the second adding circuit,
if the full operand enable signal is set, the result of the multiplication by the second multiplier minus the result of the multiplication by the first multiplier and minus the result of the multiplication by the third multiplier, times two to the power of the number of bits which the least significant bit portions of the operands each hold, and if the full operand enable signal is set, the carry from the sum determined by the first adding circuit.

6. The processing circuit of claim 5, wherein the output circuit is configured to disable a propagation of the carry from the low significant bit portion of the output sum to the most significant bit portion of the output sum if the full operand enable signal is not set.

7. The processing circuit of claim 5, wherein the least significant portion of the output sum comprises two times the number of bits that the least significant bit portions of the operands each hold.

8. The processing circuit of claim 1, wherein the output circuit is configured to omit the result of the multiplication by the second multiplier minus the result of the multiplication by the first multiplier and minus the result of the multiplication by the third multiplier, times two to the power of the number of bits which the least significant bit portions of the operands each hold from the output sum if the full operand enable signal is not set.

9. The processing circuit of claim 1, wherein the output circuit comprises a summing circuit configured to calculate the output sum and a gating circuit configured to supply the result of the multiplication by the second multiplier minus the result of the multiplication by the first multiplier and minus the result of the multiplication by the third multiplier to the summing circuit if the full operand enable signal is set and to supply a zero to the summing circuit if the full operand enable signal is not set.

10. A data processing circuit, comprising:
a first sub-circuit and a second sub-circuit each according to the processing circuit of claim 1,
an input circuit configured to supply a least significant bit portion of a first binary value as the first operand to the first sub-circuit and a least significant bit portion second binary value as the second operand to the first sub-circuit;
an additional multiplier configured to multiply the sum of the most significant bit portion of the first binary value and the least significant bit portion of the first binary value with the sum of the most significant bit portion of the second binary value and the least significant bit portion of the second binary value; and
an additional output circuit configured to:
determine an output sum including:
the result output by the first sub-circuit,
the result output by the second sub-circuit times two to the power of two times the number of bits which the least significant bit portions of the binary values each hold, and
depending on whether or not the full operand enable signal is set, the result of the multiplication by the additional multiplier minus the result output by the first sub-circuit and minus the result output by the second sub-circuit, times two to the power of the number of bits which the least significant bit portions of the binary values each hold; and
to output the output sum as end result.
